(19) United States
(12) Patent Application Publication
(10) Pub. No.: US 2025/0002392 A1
(43) Pub. Date: Jan. 2, 2025

(54) A GLASS COMPOSITION COMPRISING POLYHALITE AND A PROCESS FOR THE PRODUCTION THEREOF

(71) Applicant: ICL EUROPE COOPERATIEF U.A., Amsterdam (NL)

(72) Inventors: Khalil ABU-RABEAH, Beer Sheva (IL); Amir GERBER, Sheizaf (IL)

(21) Appl. No.: 18/707,584

(22) PCT Filed: Nov. 6, 2022
(86) PCT No.: PCT/IL2022/051174

§ 371 Date: May 5, 2024

Related U.S. Application Data
(60) Provisional application No. 63/276,737, filed on Nov. 8, 2021.

(51) Int. Cl. C03C 1/00; C03B 5/235; C03C 3/091; C03C 3/11

(52) U.S. Cl. CPC C03C 1/004; C03B 5/235; C03C 3/091; C03C 3/11

(57) ABSTRACT

According to some embodiments, there is provided herein a glass composition comprising Polyhalite.

### FIELD OF THE INVENTION

The present invention relates to the field of glass manufacturing, specifically to the production of glass comprising polyhalite.

### BACKGROUND OF THE INVENTION

Glass manufacturing is an age-old process. There is evidence that in the Levant 7000Bc people discovered how to produce glass.

Glass is a transparent amorphous solid. The majority of glass nowadays is used for manufacturing windows and bottles, whereas most of the glass around the world is based on soda-line-silica.

The usual raw materials for glass are: soda ash, limestone and silica sand, whereas the carbonate decomposes to oxide form CaO, Na₂O.

(In glass about 75% silica, about 18% Na₂O and about 7% CaO).

During the production of glass, the soda-lime-silica mixture is melted at 1600 degrees, whereas carbon dioxide is emitted during the process. The melt is cooled slowly to around 1000 degrees and annealed around 500. During the cooling phase various combinations of CaO—Na₂O—SiO₂ may be formed.

Minor components can have great influence on the melting process and on the yielded glass character. For example, adding transition metal may change the color of the glass: iron, cobalt, nickel and the like, may change the color of the glass to green, brown, blue. Adding lithium may reduce the temperature required to have a melt.

It is known that a sulphate anion can effect some parameters during the melting of the soda-lime-silica. For example, sulphates and some Sulphur derivatives may affect the melting reactions and coloring mechanism. Various effects may depend on the solubility of the Sulphur derivatives, whereas the solubility extent results from the level of oxidation of the Sulphur derivatives.

Potassium carbonate can used as a flux in glass production. It increases the resistance, transparency, and refractive coefficient of glass to give it excellent clarity, making it appropriate in special uses like computer and television screens. (K₂CO₃ decompose to K₂O). Potash glass is a hard glass that is made with K₂O—CaO—SiO₂. The strength of potash gives the glass special character and relatively high heat resistance temperature.

Potassium carbonate is also often used in glass manufacturing, providing the resulting glass high heat resistance, for example, in Pyrex glass. Potassium carbonate is also used for the production of strengthened glass, lending it exceptional durability, strength and properties that allow it to be used in extreme conditions, for example in airplanes.

Potassium carbonate also creates a high refractive index in glasses used for optical devices like eyeglasses, cameras, microscopes, telescopes and other optical instruments.

Polyhalite is an evaporite mineral, a hydrated sulfate of potassium, calcium and magnesium with formula: K₂Ca₂Mg(SO₄)₄·2H₂O. Polyhalite is used as a fertilizer since it contains four important nutrients and is low in chloride:
48% SO₃ as sulfate
14% K₂O
6% MgO
17% CaO

Sulphates which are primarily used as fining agents in soda-lime-silica glass batches, affect many parameters during melting. Depending on the oxidation state of the medium, sulphates can give various reactions during batch melting, resulting in the formation of sulphate. Sulphates and these sulphur species affect the melting reactions, conduct fining of the fresh melt and take a determining role in the colouring mechanism. Solubility of the above mentioned sulphur species mainly depends on the oxidation state of the batch, but the basicity of the glass, the temperature of the melt and the water content of the furnace atmosphere are also important parameters. If the only purpose of sulphate addition is to aid melting and fining, as in oxidized or slightly reduced flint glass batches, then the amount of sulphate added to the batch should be adjusted to just achieve an acceptable fining quality in the product. However producers sometimes add more sulphate to the batch than the process needs in order to ensure good quality. In such cases the excess sulphate will be exhausted as flue gas, resulting in higher emissions and higher batch costs. Thus, the optimization of sulphate usage is important in order to optimise fining, batch cost and emissions. If the aim of sulphate addition to the batch includes colouring of the glass in addition to fining, as in highly reduced amber glass, then the determination of the necessary amount of sulphate becomes more complex. The fining mechanism and the solubility of the sulphur species will be different than in the oxidized glasses, and the formation of the amber chromophore, requires some reduced sulphur species as well as iron oxide. This article reviews some of the recent work on the issues related to sulphate reactions taking place in soda-lime-silica glasses, including examples from practical experience.

### BRIEF DESCRIPTION OF THE FIGURES

FIG. 1 is a diagram of stress profiles obtained by chemical and thermal strengthening, according to some demonstrative embodiments of the present invention.

FIG. 2. is a photo of a clear glass made of 80% Sodium glass and 20% polyhalite inside the Pt crucible, according to some demonstrative embodiments of the present invention.

### SUMMARY OF THE INVENTION

According to some demonstrative embodiments, there is provided herein a glass composition comprising Polyhalite.

According to some embodiments, the Polyhalite may be in a concentration between 0.1-40% w/w, preferably, 0.1-10% w/w.

According to some embodiments, the Polyhalite may act as a strengthening agent and is in a concentration of 5-40% w/w.

According to some embodiments, the Polyhalite may act as a fining agent and is in a concentration of 0.1-5% w/w, preferably, 0.1-1% w/w.

According to some embodiments, there is provided herein a process for the production of a glass composition, comprising at least two steps:
a first step of melting or dissolving Polyhalite in sodium glass or in pure SiO₂ powder, to provide a glass mixture; and
a second step of loading said glass mixture into a crucible and heating to 1200-1800° C. to result in said glass composition.

According to some embodiments, the polyhalite may be in a concentration of 0.1-40% w/w, preferably 0.1-10% w/w.

According to some embodiments, the polyhalite may be in a concentration of 0.1-5% w/w.

According to some embodiments, the loading of the glass mixture into the crucible may be done for 0.5-2 hours.

According to some embodiments, there is provided herein a use of polyhalite in the process of manufacturing glass.

### DETAILED DESCRIPTION OF THE INVENTION

According to some demonstrative embodiments, there is provided herein a glass composition comprising Polyhalite (also referred to herein as “Polysulphate”). According to some embodiments, the polyhalite acts as the main source of sulphate, calcium, magnesium and potassium.

According to some embodiments, the polyhalite may act as a molten salt used for the chemical strengthening of glass and/or as a raw material to make glass itself.

According to some embodiments, despite its relatively low concentration in potassium, high concentration in calcium and high melting point, Polyhalite may surprisingly be used for chemical strengthening of glasses. According to some other embodiments, Polyhalite may be used as a fining agent in glasses, for example, soda lime, E-glasses and the like. According to these embodiments, the amount of polyhalite used as a fining agent may preferably be about 1% w/w or less, of the raw material batch.

According to some embodiments, the low iron content of the Polyhalite may make it a particularly useful raw material for low iron containing float, flint container and tableware glasses.

According to some embodiments, the glass composition of the present invention may preferably include float, flint container and tableware glasses.

According to some embodiments, the glass composition comprising Polyhalite, e.g., in a concentration of 1-10% w/w, preferably 3.75% w/w, could allow a CO₂ decreased batch (for example, about 6% decrease). According to some embodiments, the energy demand of such a glass composition may also be lower ordinary glass production processes, e.g., as there are less gases to be heated, resulting in lower energy consumption.

According to some embodiments, the use of Polyhalite may be efficient both in the production of glass, and in the presence within the final glass product.

According to some embodiments, the Polyhalite, being a composite mineral, possesses unique hardness (Mohs of 2.5-3.5), a specific gravity of 2.8 and minimal white to gray coloring, often colorless which allows for the efficient blending within a glass composition.

According to some embodiments, the unique structure and crystal system of Polyhalite, having a triclinic structure, minimizes the formation of bubbles during the production process of the glass composition of the present invention. According to these embodiments, the exitance of bubbles in the production process of glass may result in a non-homogenous final product, which more prone to breakage or uneven transfer of light.

According to some embodiments, there is provided herein a process for the production of glass, wherein said process comprises melting or dissolving Polyhalite to act as a source of sulphate, calcium, magnesium and potassium.

According to some embodiments, the process may include a first step of melting or dissolving 5-45% w/w of Polyhalite in sodium glass or in pure SiO₂ powder, to provide a glass mixture.

According to some embodiments, the process may include a second step of loading the glass mixture into a Platinum (Pt) crucible and heating to 1200-1800° C., preferably, 1600° C. for 0.5-2 hours, preferably, 1 hour and cooling the mixture to room temperature, e.g., to result in a clear glass.

According to some embodiments, prior to the first step, the polyhalite may be ground and sieved, for example, to a size of 0.1 mm-2 mm, preferably, no more than 1 mm, e.g., thus making the grain size not have a detrimental effect on batch and glass homogeneity.

According to some demonstrative embodiments, the glass composition of the present invention may comprise polyhalite with Silica.

### Mechanical Properties, Thermal and Chemical Reinforcement

Glass is a material mostly known for its brittleness. It is rather weak in bending and tension and its theoretical strength is never fully achieved. In theory, glass should have an indicative strength of 700 MPa, but often the reality is less than 1% of that value, around 35 to 70 MPa. This is due to the inevitable surface flaws which act as a starting point for fracture. However, glass has a good compressive strength and that can be used for reinforcement. Since fracture always happens when tensile stress opens surface flaws, compressive stress at the surface will create an additional barrier that has to be overcome before opening the flaws. There are different ways to create this compressive stress such as thermal and chemical strengthening.

Thermal strengthening consists of heating the glass above its transition temperature and quenching it fast enough so that the outer layers of the glass product cool faster than its core. When the core starts cooling and contracting, it pulls on the already cold surfaces, creating some compressive stress at the surface, and some tensile stress in the core.

Thermally strengthened glass is widely used in architecture, automotive and transportation, and for some tableware articles. Depending on the thermal history, the surface compression can reach between 35 and 150 MPa. The layer under compression is approximately 20% of the total thickness of the glass piece.

When the glass is thin and/or when a higher level of compressive stress must be generated, chemical tempering can be applied. This technique is often called “ion stuffing” and consists of replacing ions present in the glass (generally sodium, sometimes lithium) with some larger ions (generally potassium). Since potassium is larger than sodium or lithium ions, it pushes on the glass structure and creates compressive stress on the surface. The layer under compression is thinner (generally under 100 μm) but the level of stress is much higher, up to 900 MPa.

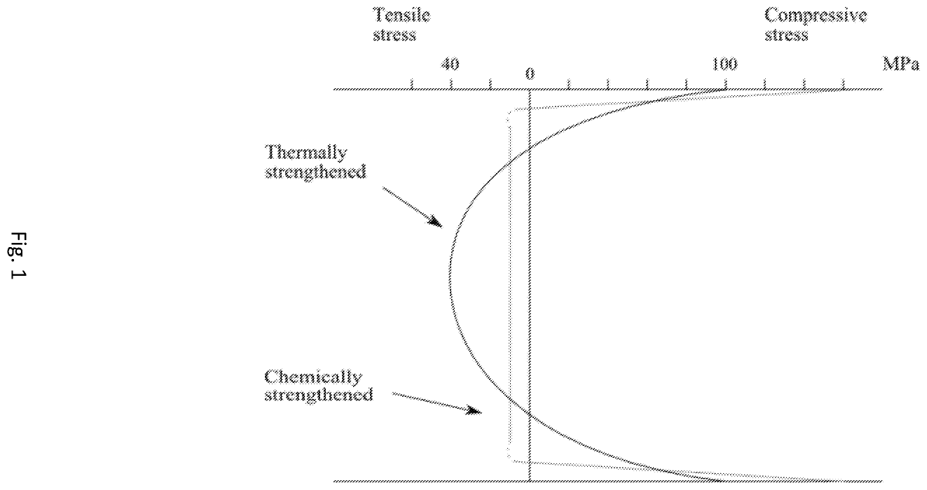

Reference is made to FIG. 1, which depicts a diagram of stress profiles obtained by chemical and thermal strengthening.

### Principle of Chemical Strengthening

Chemical strengthening is based on a diffusion-controlled ion exchange between the glass and another medium. It is therefore temperature and time-dependent. The temperature at which the process takes place is defined by the glass itself. The temperature must be as high as possible to activate the diffusive exchange, but it should not be too high, otherwise, the stress generated in the glass by the process is relaxed or eliminated by viscous flow. This means that the glass viscosity cannot exceed the so-called strain point (defined as when log viscosity=13.5 Pa·s). This viscosity corresponds to a temperature between 50° and 550° C. for alkali aluminosilicate glasses. The applied exchange temperature is therefore generally below 550° C. for most glass types

One of the most common exchange is the substitution of sodium by potassium. Chemical tempering can be applied to common soda-lime silicate glasses, but the level of strengthening is not very high since that glass type relaxes rather quickly. Glasses designed for chemical tempering are alkali aluminosilicate glasses. They often contain a high level of Na₂O (over 10%) and a very high concentration of Al₂O₃ (5 to 20 wt % instead of 1.5% in common glass). The high alkali content prepares the glass for ion exchange with larger alkali ions to improve the surface compressive strength. The alumina (as well as zirconia) is known to enhance sodium/potassium interdiffusivity. Often, glasses designed for tempering often contain traces of CaO instead of the usual 10% in common glasses. The calcium ion is a similar size to the sodium ion and somehow blocks the diffusion pathway of sodium.

The most common procedure for chemical tempering consists in dipping the glass into a bath of molten salt, often KNO₃. An alternative to the use of a molten salt bath is the preparation of a paste that is applied to the glass before thermal treatment. This paste is obtained by mixing the alkali ion in a carrier agent such as clay. The strength achieved is in the same range as with salt baths, but this process requires more effort in coating and cleaning the glass and there is a risk that the glass surface is not completely in contact with the paste. Solid phase reagents can also be used. Logically, the diffusion rate is slower in the solid than in the liquid state, therefore higher temperatures or longer times are required, leading to lower strength and smaller diffusion depth.

### Strengthening and Diffusion

Alkali exchange in glass is a diffusion-controlled reaction and therefore it can be described using Fick's law which states that the flux J over a distance x is proportional to the concentration gradient of a specie between a medium 1 and a medium 2. The proportionality factor, D, is the diffusion coefficient.

$$J = \overline{D} \frac{{C}_{1} - {C}_{2}}{x}$$

In the case of a binary ion exchange, the two diffusion species N and K may diffuse at different rates. Therefore, the interdiffusion (sometimes called effective diffusion) coefficient D which is a function of the two individual diffusion coefficients D and the ionic fraction N is often used.

$$\overline{D} = \frac{{D}_{N} {D}_{K}}{{D}_{N} {N}_{N} + {D}_{K} {N}_{K}}$$

Since the compressive stress increases linearly with the concentration of potassium in the diffusion layer, it is interesting to have a high diffusion coefficient. Diffusion can be enhanced by radiation (Radiation Enhanced Diffusion) or by applying a DC electrical field (Field assisted ion exchange). However, in practice, the parameters used are mostly time and temperature. Diffusion coefficients follow an Arrhenius law with regard to the temperature:

$$D ( T ) = {D}_{0} {e}^{- ( \frac{E}{RT} )}$$

For commercial float glass and a mixture of KNO₃/KCl, the values of D range between 1.5 10⁻¹¹ cm²s⁻¹ at 460° C. to 6.1 10⁻¹¹ cm²s⁻¹ at 520° C. and were shown to be independent of the potassium nitrate/chloride ratio. For simplified alumino silicate glasses in contact with pure KNO₃ at 460° C., the coefficient ranged between 2 10⁻¹⁰ and 8 10⁻¹⁰ depending on the alumina content of the glass.

Some additives in the bath can improve the final strength of the glass. Adding sources of potassium with a different anion has been shown effective in the order OH⁻>PO₄³⁻>SO₄²⁻>Cl⁻>NO₃⁻. The diffusion may be altered by the contamination of the salt bath by ions coming out of the glass. The primary contamination comes from the sodium ions entering the bath when being replaced by potassium ions. Luckily, chemical strengthening remains efficient for sodium contamination in the bath up to 1350 ppm Na. For larger Na contamination, the residual stress and strength of tempered glass are reduced by an amount up to 25%. The process is very sensitive to the presence of calcium in the bath: chemical strengthening is significantly altered when KNO₃ contains more than 20 ppm of Ca.

### Polyhalite as a Chemical Strengthening Agent

According to some demonstrative embodiments, Polyhalite may act as a strengthening agent in the preparation of the glass composition of the present invention.

According to some embodiments, Polyhalite contains potassium which may act as a diffusive element to maximize the concentration gradient and therefore the mass transport, and thus have a favorable influence on the performance of a strengthened glass.

According to some demonstrative embodiments, Polyhalite may be used as raw material in glass making.

The basis of a qualitatively correct and efficient glass manufacturing process is the selection of a suitable set of raw materials. This set of raw materials has to be adapted to the requirements of the glass product and at the same time ensure optimal melting and forming processes. Naturally, the cost price of the complete raw material batch is a very important boundary condition. As cost price is also determined by transport costs, large quantity raw materials (such as sand) are usually sourced as closely as possible to the glass production site.

According to some embodiments, in the preparation of the glass composition according to the present invention, the different raw materials may be mixed together in the required proportions. This mixture of raw materials may be referred to herein as “batch”, which may be, for example, in powder form.

According to some embodiments, external recycling cullet may be the main raw material used in some cases, especially in the glass wool and container glass industry.

According to some embodiments, the glass and glass melt properties depend on the chemical composition of the glass and temperature.

Therefore, the composition of the raw material mixture (batch) and each raw material individually, including impurities, will influence the glass (melt) properties. The correct composition of the raw materials is vital, but also grain sizes of these materials may be very important in the melting process. According to some preferable embodiments, the batch preparation, batch transport and melting process need to deliver a homogeneous glass with uniform properties.

According to some embodiments, the raw materials used in the process of preparation of a glass composition according to the present invention may give the glass its correct composition as the composition will determine most glass properties. For example, the number of different ingredients in the glass composition of the present invention may be between 3-15, preferably, 5-10, most preferably 6 to 7.

An important requirement is that the composition of the raw materials should not fluctuate in time. Therefore the composition of the different raw material ingredients should be checked frequently. The produced glass is frequently analyzed (e.g. by X-Ray Fluorescence) to control glass composition changes and to adapt batches or batch raw materials.

The naturally occurring batch ingredients, like minerals and silica sand, can contain undesirable contaminants. The most important contaminations in mineral batch ingredients may be:
Coloring oxides, especially Fe₂O₃ and Cr₂O₃.
Heavy minerals. Grains or particles containing ZrO₂, Al₂O₃, TiO₂, SnO₂, or Cr₂O₃ which are difficult to dissolve in the glass melt.
Organic material. In view of the required oxidation state (redox) of the glass, it is essential to keep the carbon content (carbon & other organic components) within certain limits. A change of the redox state can change the color of the produced glass, the radiation heat transfer in the molten glass and may influence the fining process.
Fluorine (fluorides) and chlorine (chlorides). Although fluorine and chlorine are certainly favorable for the melting-in process of raw material batches, their presence is increasingly being avoided because of tightening environmental requirements. These components evaporate to a large extent during the melting process and they are sometimes difficult to remove from the flue gases. High concentrations of chlorine and fluorine in the flue gases can attack furnace refractory construction materials.

Fluoride is often present in minerals such as kaolin/clay and chloride is an impurity in synthetic soda. Recycling of filter dust, separated from the flue gases of the furnaces by filters will also lead to increased fluoride and chloride input in the glass furnaces. Also recycling glass (cullet) can contain these elements. Dissolved chlorides in the glass may attack the mold materials in the product forming process.

The specifications of acceptance of these contaminants may vary depending on the glass composition and environmental aspects.

### Melting Behavior

According to some embodiments, the raw materials should melt down reasonably fast in a glass melting tank. Not all ingredients in the batch actually melt spontaneously upon batch heating. Some raw materials need reaction partners to form a molten reaction product (alkali-alkali earth-silicate melts) or some raw materials will dissolve in the already existing molten phases. The batch melting kinetics are determined by the dissociation or reaction temperatures of raw materials (e.g. carbonates) and the dissolution rate of the ingredients in their surrounding melt phases. The batch melting rate is most dependent on the transfer of heat into the batch blanket in a glass furnace.

Compounds like china clay (Al₂O₃·2SiO₂·2H₂O) dissolve faster than the individual pure oxides (SiO₂ and Al₂O₃), such as in a mixture of sand grains and alumina grains.

### Grain Size

According to some embodiments, grain sizes may play an important role in the preparation of the glass composition of the present invention. Large grains need a longer time for complete dissolution than smaller grains. Therefore, the grain size should not be too large. This applies especially for the ingredients, that are difficult to dissolve or to fuse, like SiO₂ and Al₂O₃.

However, the grain size should not be too small either. Using very fine batch there is a risk of materials being blown about by the combustion in the furnace (giving so-called “carry-over”) and of clogging or attack of the flue gas ducts. Very fine sand may also lead to the formation of silica scum on top of the melt. This scum will hardly melt or dissolve in the melt underneath it.

Furthermore, there should not be too large a difference in grain size between the different raw materials, because this may lead to segregation of the batch during conveying. This could result in a non-uniform batch and even inhomogeneous glass with fluctuations in chemical composition. Batch segregation can also affect the rheological properties of the batch and batch blanket. In general, the grain size distribution of all ingredients, including polyhalite, should be kept between 0.05 and 5 mm, preferably between 0.1-2 mm. According to some embodiments, for silica sand the grain size is preferably about 0.15 mm.

A finer powder may be used for glasses that are difficult to melt or for which very homogeneous melts are required (like for E-glass for continuous filament glass fibers). It is essential to mix the batch as homogeneously as possible to obtain a homogeneous final product. In general, this can be achieved better with a compacted than with a loose powder batch. A batch of grains is prone to de-mixing (segregation) when the different batch ingredients have different grain size distributions and their grains are larger than 50 micrometers. Humidification of the batch may be applied to avoid dusting and segregation.

### Gas Emissions

According to some embodiments, environmental constraints make it important to consider the gaseous emissions from glass melting.

According to some embodiments, the use of polyhalite in the process of preparation of a glass composition according to the present invention may reduce gas omissions during the process.

### CO₂ Content

Common mass-produced glasses often contain carbonates as raw material sources for alkali and alkali-earth oxides. The most widely-used carbonates are soda ash, limestone and dolomite. As the glass industry is looking to decrease its carbon footprint, the replacement of these raw materials by CO₂ free materials is becoming more and more needed, particularly in the light of the costs of CO₂ emissions.

### SO₂

SO₂ emissions are caused by sulfur content of combustion oil or gas and from the use of sodium sulfate as fining agent. Firing natural gas instead of fuel oil results in a strong decrease of the content of sulfur oxides in the flue gases.

Reduction of the amount of the fining agent, sodium sulfate, within acceptable limits leads to an extra decrease of the SO₂ emissions. Glass furnaces that use high levels of external cullet often show problems with organic contamination of the batch. Fresh cullet from collection can contain high levels of organic materials (e.g. oils, sugars, fats, food residues). These organic compounds act as reducing agents and disturb the oxidation state of the melt. Glass producers often apply an excess of sodium sulfate in the batch to compensate for the reducing power of the contaminated recycling cullet. Sodium sulphate is an oxidizing agent which reacts with the reducing components and releases sulfur oxides. This may cause foaming and high SO₂ emissions. The excess of sulfate is applied to ensure that even in the case of highly polluted cullet, the color of the glass will remain in specifications. This will increase the SO₂ emissions even more.

In general, the optimization of the batch formulation, choice of sulfur lean fuels, and selection of raw materials with stable oxidation state and low sulfur level, unless necessary for fining, will limit the SO₂ emissions. Filter dust recycling when applying a scrubber and filter system is often possible.

### Chlorine

The batch and cullet are usually the only sources for chloride emissions. Except for the possible application of NaCl as fining agent in high melting glasses (e.g. hard borosilicate glasses), chlorides are generally not added to the batch on purpose.

Sodium chloride is mainly present as an impurity in synthetic soda produced from brine by the Solvay process. Typical concentration levels in synthetic soda-ash for glass industry usage is: 0.09-0.15 mass % NaCl (±0.05-0.1 mass % Cl).

Mineral batch constituents like phonolite, dolomite, colemanite and blast furnace slag, also contain Cl−-impurities. Recycling cullet also may contain chlorides depending on the origin of the glass.

Chloride can also be found in filter dust if the flue gases are scrubbed using hydrated lime, or especially soda. This dust is removed from the flue gas by filtration. The filter dust is often recycled by adding it to the raw material batch. The CaCl₂ and NaCl in the filter dust that is returned to the glass melting furnace will partly evaporate again. Thus, this recycling will increase the total concentrations or vapor pressures of chloride species (e.g. NaCl vapor) in the furnace atmosphere and regenerators. High NaCl vapor pressures can attack the glass furnace refractory materials. Thus the combination of scrubbing and filter dust recycling may lead to furnace damage.

The chloride emissions depend on the total chloride content of the batch, the type of chlorides (the chloride incorporation in the raw materials and cullet) and melting rate.

Chlorides volatilize mainly as NaCl vapor. The glass melt has a limited solubility of sodium chloride and this limited solubility (high NaCl activity) will result in rather high NaCl vapor pressures and large NaCl losses from the melt. When the batch melts quickly, the total evaporation of chlorides will decrease, because the chloride is less volatile in the dissolved (in the melt) form.

A part of the chlorides will be incorporated in the glass, depending on temperature and glass composition. However, a large part of the chlorides, introduced via the batch evaporates mainly as alkali chlorides, probably a smaller part vaporizes as HCl. During the process of cooling down of the flue gases, most chlorides (mainly NaCl) react with flue gas components (water vapor and sulfur oxides) into hydrochloric acid (HCl) and particulate alkali sulfate. Thus, a high chloride content in the batch will promote the evaporation of alkali (sodium or potassium), which will also increase the dust content (Na₂SO₄):

2NaCl+SO₂+H2O+½O₂→Na₂SO₄(dust)+2HCl(gas)

In the flue gases at lower temperatures: <750° C., chlorine occurs mainly as HCl-gas, which is both strongly corrosive and hazardous for the environment.

Decrease of the chloride emissions is possible by decreasing the chloride content in the raw materials. Good selection of low chlorine content raw materials and cullet is therefore important.

According to some embodiments, polyhalite may

### Costs

The cost price of the mineral raw materials is mainly determined by the production technology, synthesis (for synthetic raw materials), the transportation costs and the degree of pre-treatment, such as milling and purifying.

According to some demonstrative embodiments, the use of polyhalite in the process for the production of the glass composition of the present invention may reduce the costs involved in the production process.

According to some demonstrative embodiments, in the process described herein polyhalite may act as a fining agent. According to some embodiments, as a fining agent, polyhalite may be added to the raw material batch to aid removal of small bubbles from the molten glass. As most glasses are produced from carbonate containing raw materials, a large amount of (mainly) CO₂ may be generated during the batch to glass conversion process. The initial glass is a viscous mass of glass, dissolving raw materials and many gas bubbles. The fining agent is chosen which decomposes or reacts forming gas at a temperature where the glass viscosity is sufficiently low to enable the growth and ascent of the bubbles. The gas diffuses from the melt into the bubbles causing them to grow and therefore promoting the ascent of the bubbles out of the melt.

Most commercial soda lime glasses use salt cake (Na₂SO₄) as fining agent. Salt cake melts at 884° C. and the molten compound reacts easily with other silicates in the melt, also known as a fluxing agent or melt enhancer. Depending on the oxidation state (redox) of the melt and amount of salt cake added, the sulphate decomposes at temperatures from about 1400° C. to give SO₂ and O₂. These gases diffuse through the melt into the bubbles, causing the bubbles to grow and so aid their ascent out of the melt. According to some demonstrative embodiments, when used as a fining agent, polyhalite may be used in an amount of up to 5% w/w, preferably up to 2% w/w, most preferably up to 1% w/w.

According to these embodiments, limiting the amount of Polyhalite up to 5%, let alone, below 1% w/w, limits the amount of chlorine and SO₃ in the process of production and the final product (excessive amounts of SO₃ may lead to gas formation (SO₂) causing foaming and undesirably high SO₂ emissions).

### Grain Size

According to some embodiments, the particle size distribution of Polyhalite is presented in Table 1

TABLE 1
Typical particle size
of polyhalite

| | Typical |
|---|---|
| Mesh | retained |
| size | range |
| [mm] | [%] |
| 2.00 | 0-2 |
| 1.00 | 10-30 |
| 0.85 | 20-50 |
| 0.60 | 40-80 |

According to some demonstrative embodiments, the polyhalite used in the preparation of a glass composition according to the present invention may be crushed or ground before processing.

According to some demonstrative embodiments, after crushing or grinding the polyhalite, the desired polyhalite particle size should preferably be between 0.1 mm and 2 mm.

According to some embodiments, polyhalite may be used as molten salt for chemical strengthening of the glass composition of the present invention.

According to some other embodiments, polyhalite may be used as glass making raw material, for example, as fining agent, e.g., in soda lime, E-glasses and the like.

According to some embodiments the low iron content of Polyhalite may allow for polyhalite to be used for the preparation of low iron containing float, flint container, tableware glasses and the like.

According to some embodiments, the concentration of polyhalite in the process of production of the glass composition of the present invention may vary, and range from 0.1-40% w/w, preferably up to 10% w/w.

### Example 1

The dissolution of polyhalite in sodium glass (Soda-lime glass) and pure SiO₂ was tested.

20% w/w and 40% w/w of Polyhalite were mixed with either sodium glass or pure SiO₂ powders. The compositions of starting materials are presented in Table 2 below.

TABLE 2
Composition of starting materials as measured by XRF

| | Sodium glass | | SiO₂ | | Polyhalite | |
|---|---|---|---|---|---|---|
| | Wt % | Error | Wt % | Error | Wt % | Error |
| Na₂O | 2.184 | 0.07 | | | 0.177 | 0.02 |
| MgO | 0.695 | 0.02 | | | 0.934 | 0.03 |
| Al₂O₃ | 1.627 | 0.05 | | | 0.027 | 0.005 |
| SiO₂ | 81.204 | 0.3 | 99.887 | 0.009 | 0.26 | 0.02 |
| P₂O₅ | 0.042 | 0.007 | 0.073 | 0.3 | | |
| SO₃ | 0.511 | 0.03 | | | 70.582 | 0.2 |
| Cl | 0.121 | 0.02 | 0.04 | 0.008 | 7.786 | 0.09 |
| K₂O | 0.177 | 0.01 | | | 8.226 | 0.08 |
| CaO | 12.926 | 0.1 | | | 11.692 | 0.1 |
| TiO₂ | 0.12 | 0.01 | | | | |
| Fe₂O₃ | 0.284 | 0.02 | | | 0.046 | 0.006 |
| ZnO | 0.073 | 0.008 | | | | |
| SrO | 0.031 | 0.005 | | | 0.243 | 0.01 |

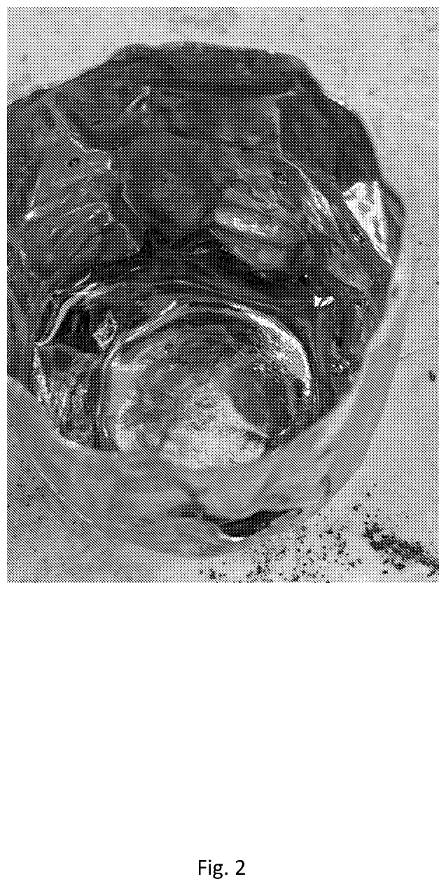

About 10 gr of the mixtures were then loaded into a Platinum (Pt) crucible and heated to 1600° C. for 1 hour and cooled within the furnace. The resulted material was a clear glass inside the Pt crucible (see FIG. 2) FIG. 2. is a photo of a clear glass made of 80% Sodium glass and 20% polyhalite inside the Pt crucible.

The composition of the resulted glass was checked using XRF. According to the XRF results, most of the sulfur was evolved during the process, and all other cations were dissolves inside the glass. It is therefore concluded that Polyhalite completely dissolves in the glass melt.

TABLE 3
Composition of starting mixtures and glasses
after 1600° C. materials as measured by XRF

| | 80% SG + 20% Poly | | | | 60% SG + 40% Poly | | | |
|---|---|---|---|---|---|---|---|---|
| | mix | | glass | | mix | | glass | |
| | Wt % | Error | Wt % | Error | Wt % | Error | Wt % | Error |
| Na₂O | 1.353 | 0.05 | 4.559 | 0.08 | 0.718 | 0.03 | 2.655 | 0.07 |
| MgO | 0.996 | 0.03 | 1.915 | 0.04 | 1.003 | 0.03 | 2.001 | 0.04 |
| Al₂O₃ | 0.982 | 0.03 | 1.755 | 0.04 | 0.564 | 0.02 | 1.358 | 0.04 |
| SiO₂ | 48.493 | 0.2 | 70.15 | 0.2 | 25.493 | 0.1 | 64.487 | 0.2 |
| P2O₅ | 0.018 | 0.004 | 0.029 | 0.005 | | | 0.019 | 0.004 |
| SO₃ | 28.569 | 0.2 | 0.596 | 0.02 | 49.523 | 0.2 | 0.415 | 0.02 |
| Cl | 2.972 | 0.07 | 0.048 | 0.007 | 4.944 | 0.08 | — | — |
| K₂O | 3.049 | 0.05 | 3.494 | 0.06 | 5.094 | 0.07 | 6.616 | 0.07 |
| CaO | 13.171 | 0.1 | 16.947 | 0.1 | 12.33 | 0.1 | 21.692 | 0.1 |
| TiO₂ | 0.07 | 0.008 | 0.1 | 0.009 | 0.05 | 0.007 | 0.116 | 0.01 |
| Cr₂O₃ | | | 0.012 | 0.003 | | | 0.018 | 0.004 |
| MnO | | | | | | | 0.021 | 0.004 |
| Fe₂O₃ | 0.225 | 0.01 | 0.209 | 0.01 | 0.126 | 0.01 | 0.272 | 0.02 |
| ZnO | 0.008 | 0.003 | 0.038 | 0.006 | | | 0.01 | 0.003 |
| SrO | 0.094 | 0.009 | 0.091 | 0.009 | 0.155 | 0.01 | 0.231 | 0.01 |
| ZrO₂ | | | 0.057 | 0.007 | | | 0.09 | 0.009 |

TABLE 4
Composition of starting mixtures SiO2 + Poly and
glasses after 1600° C. as measured by XRF

| | 80% SiO2 + 20% Poly | | | | 60% SiO2 + 40% Poly | | | |
|---|---|---|---|---|---|---|---|---|
| | mix | | Glass | | mix | | Glass | |
| | Wt % | Error | Wt % | Error | Wt % | Error | Wt % | Error |
| Na₂O | 0.047 | 0.008 | | | 0.215 | 0.02 | | |
| MgO | 0.309 | 0.02 | 0.441 | 0.02 | 0.764 | 0.03 | 1.172 | 0.03 |
| Al₂O₃ | 0.075 | 0.008 | 0.076 | 0.009 | 0.052 | 0.007 | 0.084 | 0.009 |
| SiO₂ | 76.064 | 0.2 | 92.139 | 0.3 | 52.541 | 0.2 | 81.874 | 0.2 |
| P₂O₅ | | | | | | | | |
| SO₃ | 17.047 | 0.1 | | | 32.687 | 0.1 | 0.253 | 0.02 |
| Cl | 1.126 | 0.04 | | | 2.186 | 0.05 | | |
| K₂O | 2.121 | 0.04 | 2.502 | 0.05 | 4.845 | 0.06 | 5.747 | 0.07 |
| CaO | 3.124 | 0.05 | 4.581 | 0.06 | 6.584 | 0.07 | 10.399 | 0.09 |
| TiO₂ | | | | | | | | |
| Cr₂O₃ | | | | | | | | |
| MnO | | | | | | | | |
| Fe₂O₃ | 0.027 | 0.005 | 0.034 | 0.006 | 0.025 | 0.005 | 0.061 | 0.007 |
| ZnO | | | | | | | | |
| SrO | 0.06 | 0.007 | 0.084 | 0.009 | 0.101 | 0.01 | 0.182 | 0.01 |
| ZrO₂ | | | 0.007 | 0.003 | | | | |

### Example 2

### Preparation of Float Glass

A typical float glass composition (in weight %) is given in Table 5 below. For the calculation it is assumed that the fining behavior of Polyhalite is similar to salt cake and its effect on the batch redox behavior (the so-called Simpson redox factor) is similar to calcium sulfate.

TABLE 5

| | SiO₂ | Al₂O₃ | Fe₂O₃ | CaO | MgO | Na₂O | K₂O | TiO₂ | Cl | SO₃ |
|---|---|---|---|---|---|---|---|---|---|---|
| reference | 70.74 | 1.00 | 0.080 | 9.25 | 4.00 | 14.30 | 0.35 | 0.03 | 0.00 | 0.250 |
| using | 70.74 | 0.97 | 0.076 | 9.25 | 4.00 | 14.30 | 0.42 | 0.03 | 0.01 | 0.213 |
| Polyhalite | | | | | | | | | | |

The calculated batch recipes for float glass are provided below in table 6

TABLE 6

| | | alternative |
|---|---|---|
| | | batch with |
| weight % | reference | polyhalite |
| sand | 56.81 | 56.85 |
| soda ash | 19.33 | 19.71 |
| limestone | 5.48 | 5.38 |
| nepheline | 2.92 | 2.80 |
| dolomite | 14.87 | 14.70 |
| salt cake | 0.525 | 0 |
| cokes | 0.017 | 0.007 |
| Fe2O3 | 0.039 | 0.036 |
| Polyhalite | 0 | 0.507 |

### Example 3

### Preparation of Flint Container Glass

A typical flint container glass composition is calculated from the standard batch and one where polyhalite replaces the salt cake. Container glass often contains a large amount of recycled glass (external cullet)—up to 90% for some green and amber colored glasses.

TABLE 7

| | SiO₂ | Al₂O₃ | Fe₂O₃ | CaO | MgO | Na₂O | K₂O | Cl | SO₃ |
|---|---|---|---|---|---|---|---|---|---|
| reference | 73.25 | 1.02 | 0.028 | 11.82 | 1.89 | 11.74 | 0.024 | 0.00 | 0.23 |
| using | 73.20 | 1.00 | 0.028 | 11.80 | 1.87 | 11.72 | 0.152 | 0.02 | 0.21 |
| Polyhalite | | | | | | | | | |

The calculated batch recipes for flint container glass are provided below in Table 8

The final column in table 8 shows a batch with a larger amount of Polyhalite (3.77%). This larger amount provides calcium, potassium and magnesium oxides, allowing for a decrease of limestone, feldspar and dolomite in the batch. A potential saving of about 6% CO₂ is possible using such amount of Polyhalite. Saving CO₂ gives cost price savings in CO₂ emission taxes and potential melting energy savings.

TABLE 8

| | | alternative | alternative |
|---|---|---|---|
| | | batch | batch |
| | | with low | with higher |
| | | conc. of | conc. of |
| weight % | reference | Polyhalite | Polyhalite |
| sand | 58.92 | 58.92 | 58.21 |
| soda ash | 15.58 | 16.13 | 15.91 |
| limestone | 13.94 | 13.80 | 13.24 |
| feldspar | 3.81 | 3.73 | 3.28 |
| dolomite | 6.94 | 6.63 | 5.32 |
| salt cake | 0.764 | 0 | 0 |
| cokes | 0.036 | 0.02 | 0.275 |
| Polyhalite | 0 | 0.775 | 3.77 |

### Example 4

### Preparation of E-Glass

The typical raw materials applied for the production of E-glass are sand (flour), kaolin, colemanite and limestone. Some glass manufacturers also add a small percentage (up to 0.5 wt %) of fining agent-salt cake or gypsum is applied. Polyhalite was tested as a fining agent.

A typical E-glass composition (in weight %) is given in Table 9 below. For the calculation it is assumed that the fining behavior of Polyhalite may be similar to salt cake and its effect on the batch redox behavior (the so-called Simpson redox factor) is similar to calcium sulfate.

TABLE 9

| | SiO₂ | Al₂O₃ | B₂O₃ | Fe₂O₃ | CaO | MgO | Na₂O | K₂O | SO₃ |
|---|---|---|---|---|---|---|---|---|---|
| reference | 55.69 | 14.14 | 6.11 | 0.372 | 22.31 | 0.31 | 0.31 | 0.75 | 0.02 |
| using | 55.53 | 14.24 | 6.24 | 0.374 | 22.35 | 0.36 | 0.03 | 0.86 | 0.02 |
| Polyhalite | | | | | | | | | |

The batches calculated to produce the glasses are given in Table 10. In this example the batch consists of 100% raw materials.

TABLE 10

| | | alternative |
|---|---|---|
| | | batch with |
| weight % | reference | Polyhalite |
| sand | 27.70 | 27.45 |
| kaolin | 32.97 | 33.19 |
| limestone | 27.75 | 27.47 |
| colemanite | 11.02 | 11.26 |
| salt cake | 0.536 | 0 |
| cokes | 0.030 | 0.024 |
| Polyhalite | 0 | 0.611 |

While this invention has been described in terms of some specific examples, many modifications and variations are possible. It is therefore understood that within the scope of the appended claims, the invention may be realized otherwise than as specifically described.

1. A glass composition comprising Polyhalite.

2. The composition of claim 1, wherein said Polyhalite is in a concentration between 0.1-10% w/w.

3. The composition of claim 2, wherein said Polyhalite acts as a strengthening agent and is in a concentration of 5-10% w/w.

4. The composition of claim 2, wherein said Polyhalite acts as a fining agent and is in a concentration of 0.1-5% w/w.

5. The composition of claim 4, wherein said Polyhalite acts as a fining agent and is in a concentration of 0.1-1% w/w.

6. A process for the production of a glass composition, comprising at least two steps:
a first step of melting or dissolving Polyhalite in sodium glass or in pure SiO₂ powder, to provide a glass mixture; and
a second step of loading said glass mixture into a crucible and heating to 1200-1800° C. to result in said glass composition.

7. The process of claim 6, wherein said polyhalite is in a concentration of 0.1-10% w/w.

8. The process of claim 7, wherein said polyhalite is in a concentration of 0.1-5% w/w.

9. The process of claim 6, wherein said loading said glass mixture into said crucible is done for 0.5-2 hours.
